(19) United States
(12) Patent Application Publication
(10) Pub. No.: US 2023/0120908 A1
(43) Pub. Date: Apr. 20, 2023

(54) Three-Dimensional Printer with Precision Vertical Positioner for Very Heavy Articles

(71) Applicant: 3D Systems, Inc., Rock Hill, SC (US)

(72) Inventor: Turner Ashby Cathey, Rock Hill, SC (US)

(21) Appl. No.: 17/966,163

(22) Filed: Oct. 14, 2022

Related U.S. Application Data
(60) Provisional application No. 63/255,646, filed on Oct. 14, 2021.

(51) Int. Cl. B22F 12/00; B33Y 30/00; B22F 12/30

(52) U.S. Cl. CPC B22F 12/222; B33Y 30/00; B22F 12/30; B22F 12/38

(57) ABSTRACT

A three-dimensional (3D) printing system includes a print engine chassis, a build box, a vertical movement mechanism, a powder dispensing module, a consolidation module, and a controller. The print engine chassis defines a build chamber configured to receive and support the build box. The build box includes a build plate upon which the 3D article is fabricated. The vertical movement mechanism includes a plurality of actuators configured to collectively provide precise positioning of the build plate. The controller is configured to (1) operate the vertical movement mechanism including operating the plurality of actuators to position an upper surface of the 3D article generally proximate and parallel to a build plane, (2) operate the powder dispensing module to dispense a new layer of powder over the upper surface, and (3) operate the consolidation module to selectively consolidate the new layer of powder.

### CROSS-REFERENCE TO RELATED APPLICATIONS

This non-provisional patent application claims priority to U.S. Provisional Application Ser. No. 63/255,646, Entitled “Three-Dimensional Printer with Precision Vertical Positioner for Very Heavy Articles” by Turner Ashby Cathey, filed on Oct. 14, 2021, incorporated herein by reference under the benefit of U.S.C. 119(e).

### STATEMENT OF GOVERNMENT GRANT

This invention was made with government support under Subaward Agreement No. 2242-201-2014154 awarded by Clemson University under Agreement No. W911NF-20-2-0237 awarded by the U.S. Army Research Office. The government has certain rights to this invention.

### FIELD OF THE INVENTION

The present disclosure concerns an apparatus and method for a layer-by-layer fabrication of three dimensional (3D) articles by selectively consolidating powder materials. More particularly, the present disclosure concerns a system and method that enables production of very large but high precision 3D articles.

### BACKGROUND

Three dimensional (3D) printing systems are in rapidly increasing use for purposes such as prototyping and manufacturing high value and/or customized articles. One type of three dimensional printer utilizes a layer-by-layer process to form a three dimensional article of manufacture from powdered materials. Each layer of powdered material is selectively consolidated using an energy beam such as a laser, electron, or particle beam or bound with a polymer binder matrix. There is a desire to have large capacity systems that can fabricate physically large articles. At the same time there is a desire to maintain precision tolerances. This can be difficult with large and heavy articles, particularly those weighing more than a ton or more than 2,000 pounds.

### SUMMARY

In an aspect of the invention, a three-dimensional (3D) printing system includes a print engine chassis, a build box, a vertical movement mechanism, a powder dispensing module, a consolidation module, and a controller. The print engine chassis defines a build chamber that is configured to receive and support the build box. The build box includes a build plate upon which the 3D article is fabricated. The vertical movement mechanism includes a plurality of actuators configured to collectively provide precise positioning of the build plate. The controller is configured to (1) operate the vertical movement mechanism including operating the plurality of actuators to position an upper surface of the 3D article generally proximate and parallel to a build plane, (2) operate the powder dispensing module to dispense a new layer of powder over the upper surface, (3) operate the consolidation module to selectively consolidate the new layer of powder, and repeat operating the vertical movement mechanism, the powder dispensing module, and the consolidation module to complete fabrication of the 3D article. The plurality of actuators can include three actuators. Operating with a plurality of actuators and particularly three actuators allows the vertical movement mechanism to provide both positional and angular positioning of the build plate.

In an implementation, the build plate has a lateral area of at least 0.5 square meter. The build plate can have a lateral area of at least 0.7 square meter, about one square meter, or more than one square meter.

In another implementation, the build box and vertical movement mechanism is configured to support more than a ton or 2,000 pounds of the 3D article and build material during fabrication. The build box and vertical movement mechanism can be configured to support at least two tons, three tons, or four tons. The build box and vertical movement mechanism can be configured to support at least 3,000 pounds, 4,000 pounds, 6,000 pounds, or 8,000 pounds.

In yet another implementation, the vertical movement mechanism is configured to vertically position the build plate with a vertical tolerance of less than 20 microns. The vertical movement mechanism can be configured to vertically position the build plate with a vertical tolerance of less than 10 microns or less than 5 microns. The actuators can be individually configured to provide vertical movement with a vertical tolerance of less than 20 microns, less than 10 microns or less than 5 microns. The accurate vertical tolerance is enabled by the use of gear reduction motion and encoders to track vertical motion and/or positioning of the build plate.

In a further implementation, the plurality of actuators individually include a motor coupled to a gear train. The gear train is configured to provide a rotational gear reduction of at least 50 to 1, at least 70 to 1, at least 80 to 1, at least 100 to 1, or at least 150 to 1. The gear train can includes a series of two or more gearboxes that individually provide a gear reduction. The high gear ratio enables precision movement of a heavily loaded build plate.

In a yet further implementation, the vertical movement mechanism includes a lift plate that engages and supports the build plate. The plurality of actuators individually include a motor, a gear train, a lead screw, and a follower. The gear train provides a rotational gear reduction from a motor shaft to the lead screw. The lead screw is vertically stationary. The follower includes a nut that receives the lead screw. Rotation of the lead screw vertically translates the follower. The follower has an upper end that engages or is coupled to the lift plate.

In another implementation, the vertical movement mechanism includes a lift plate that engages and supports the build plate. The plurality of actuators includes three actuators. The three actuators individually include a linear encoder. The linear encoder includes a follower that is coupled to the lift plate. The linear encode generates a signal that is indicative of a vertical position of the follower. The controller receives individual signals from the three linear encoders. The controller is configured to analyze the signals and to determine a height and orientation of the build plate. The controller is configured to adjust an upper surface to be parallel to and proximate to a build plane.

In yet another implementation, the vertical movement mechanism includes a lift plate that engages and supports the build plate. The vertical movement mechanism includes a plurality of (or three) cylindrical linear bearing assemblies configured to maintain a horizontal or lateral stability of the build plate. The plurality of linear bearings individually include a cylindrical guide rod and a bushing. The cylindrical guide rod has an upper end attached to the lift plate. The bearing is attached to a lower portion of the chassis and constrains a major axis of the guide rod to a vertical orientation and to vertical motion.

### BRIEF DESCRIPTION OF THE FIGURES

FIG. 1 is a schematic block diagram of an embodiment of an additive manufacturing system for producing a three-dimensional (3D) article.

FIG. 2 is a schematic diagram of a 3D print engine. In the illustrated embodiment, the 3D print engine fabricates a 3D article through a layer by layer fusion melting of metal powder layers.

FIG. 3 is an isometric drawing illustrating portions of an embodiment of a three-dimensional (3D) print engine with focus upon a vertical movement mechanism and a high capacity build box.

FIG. 4 is a cutaway view of the vertical movement mechanism and high capacity build box of FIG. 3.

FIG. 5 is a side view of a single actuator (part of the apparatus of FIG. 3) in isolation.

### DETAILED DESCRIPTION OF THE PREFERRED EMBODIMENTS

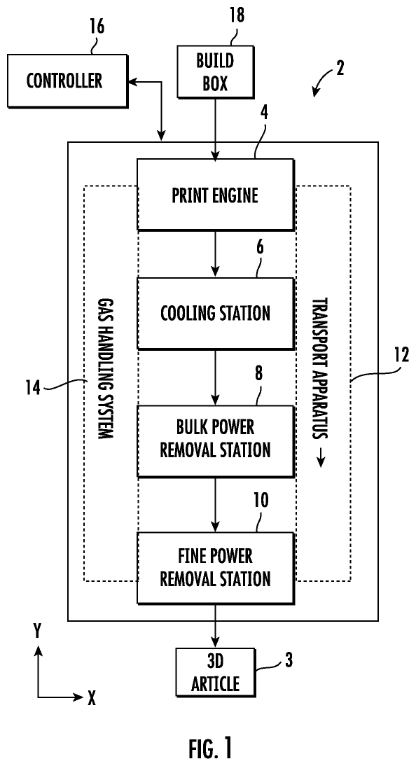

FIG. 1 is a schematic block diagram of an embodiment of an additive manufacturing (AM) system 2 for producing a three-dimensional (3D) article 3. AM system 2 includes a print engine 4, a cooling station 6, a bulk powder removal station 8, a fine powder removal station 10, a transport apparatus 12, a gas handling system 14, and a controller 16. The various components 4-14 can individually have separate “lower level” controllers for controlling their internal functions. In some embodiments, a controller can function as a central controller. In the following description, controller 16 will be considered to include all controllers that may reside externally or within the components 4-14. Controller 16 can be internal to AM system 2, external to AM system 2, or include portions that are both internal and external to AM system 2.

The transport apparatus 12 is for transporting a build box 18 through the various components 4-10 in a sequence that includes fabricating, cooling, and de-powdering (i.e., removal of residual powder) for a 3D article 3 being manufactured. The gas handling system 14 is for controlling an environment for components 4-10. In one embodiment, the gas handling system 14 is configured to evacuate components 4-10 and then to backfill them with a non-oxidizing gas such as argon or nitrogen in order to maintain the build box 18 within a non-oxidizing environment. In some embodiments, the gas handling system 14 can be several systems that are individually dedicated to individual components of the components 4-10. In an illustrative embodiment, the print engine 4 is evacuated and backfilled with non-oxidizing gas while the components 6-10 are not evacuated but are purged with a non-oxidizing gas. Yet other variations of gas handling system 14 are possible.

Controller 16 includes a processor coupled to a non-transient or non-volatile information storage device which stores software instructions. When executed by the processor, the software instructions operate any or all portions of the system 2. In an illustrative embodiment, fabrication, cooling, de-powdering, and other functions can be performed in a fully automated way by controller 16.

Controller 16 is configured to perform steps such as (1) operate gas handling system 14 to evacuate and/or backfill components 4-10, (2) operate print engine 4 to fabricate a 3D article in build box 18, (3) operate transport apparatus 12 to transport build box 18 (which now contains the 3D article and unfused powder) to the cooling station 6, (4) after an appropriate cooling time, operate transport apparatus 12 to transport build box 18 to bulk powder removal station 8, (5) operate bulk powder removal station 8 to remove most of the unfused powder from the build box 18, and (6) operate transport apparatus 12 to transport the build box 18 to the fine powder removal station 10. At the fine powder removal station 10, residual unfused powder is removed either automatically or manually. All the while, controller 16 operates the gas handling system 14 to maintain a non-oxidizing gaseous environment within the components 4-10 as required.

AM system 2 can have other components such as an inspection station or a station for facilitating unloading of the 3D article 100 from the build box 18. The additional components can be manually operated or within automated control of controller 16.

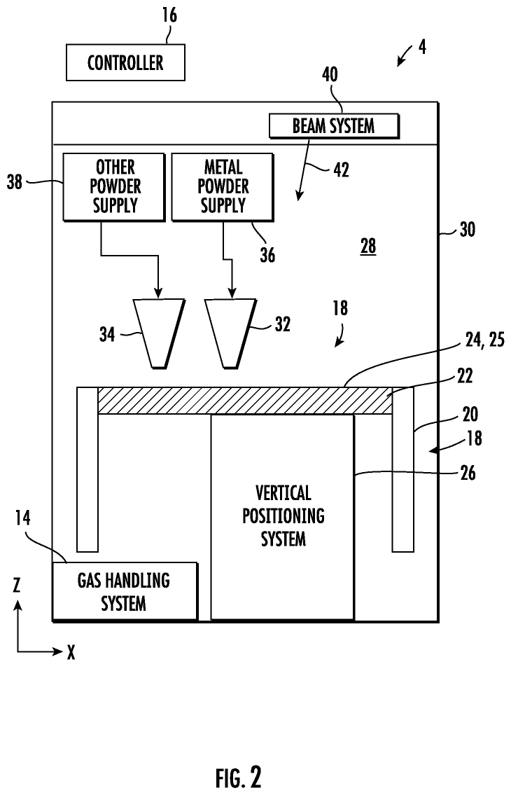

FIG. 2 is a schematic diagram of an embodiment of a 3D print engine 4. In describing FIG. 2 and for subsequent figures, mutually orthogonal axes X, Y and Z can be used. Axes X and Y are lateral axes that are generally horizontal. Axis Z is a vertical axis that is generally aligned with a gravitational reference. By “generally” it is intended to be so by design but may vary due to manufacturing or other tolerances.

The build box 18 includes a powder bin 20 containing a build plate 22. Build plate 22 has an upper surface 24 and is mechanically coupled to a vertical positioning system 26. The build box 18 is configured to contain dispensed metal powder (not shown). The build box 18 is contained within build chamber 28 surrounded by a chassis 30.

A metal powder dispenser 32 is configured to dispense layers of metal powder upon the upper surface 24 of the build plate 22 or on previously dispensed layers 24 of metal. In the illustrated embodiment, a second powder dispenser 34 is configured to dispense an additional powder such as another metal or a support material. Powder dispensers 32 and 34 are configured to receive powder from powder supplies 36 and 38 respectively. The powder dispensers 32 and 34 individually include a powder storage reservoir that is above an electronically controllable valve such as a motorized shutter. The powder dispensers 32 and 34 are individually mounted to a robotic gantry that provides three axes of motion above the build plate 22. Robotic gantries for transporting powder dispensers and other components are well known for 3D printing. Other types of powder dispensers 32 and 34 are known in the art for 3D printing.

Print engine 4 includes a beam system 40 configured to generate a beam 42 for selectively fusing layers of dispensed metal powder. In an illustrative embodiment, the beam system 40 includes a plurality of high power lasers for generating radiation beams individually having an optical power layer of at least 100 watts, at least 500 watts, or about 1000 watts or more. The beam system 40 can include optics for individually steering the radiation beams across a build plane that is coincident with an upper surface of a layer of metal powder. The optics include motorized X and Y mirrors. In an illustrative embodiment, the motorized mirrors are galvanometer mirrors. In alternative embodiments, the beam system 40 can generate and steer electron beams, particle beams, or a hybrid mixture of different beam types. Lasers, electron beam generators, and optics and other devices for routing and steering energy beams are known in the art of 3D printing.

More generally, element 40 can refer to a consolidation module 40 that can selectively consolidate powder particles in a layer-by-layer manner. The consolidation can be via fusion (thermally bonding the powder particles together directly) and/or via dispensing a binder such as a curable and/or chemically reactive liquid polymer. In various embodiments, the powder can include one or more of a polymer, metal, glass, and ceramic powder. In some illustrative embodiments, the powder can be a metal such as titanium or a metal alloy.

In the foregoing description, reference will be made to a “build plane” 25. The build plane 25 is an area over which the consolidation module 40 operates to selectively consolidate the powder material. The vertical positioning system 26 is configured to position upper surface 24 proximate to the build plane 25 before a new layer of powder is dispensed by dispenser 32. Once the new layer of powder is dispensed, it has an upper surface 24 that is generally coincident with build plane 25. The vertical positioning system 26 is also configured to adjust an orientation of the upper surface 24 about horizontal axes X and Y to assure that the upper surface 24 is generally parallel to and coincident with the build plane 25.

The controller 16 can be configured to operate the print engine 4 to fabricate a 3D article: (1) operate the vertical positioning system 26 to position an upper surface 24 of build plate 26 or of a previously deposited layer of powder at one powder layer thickness below a build plane 25, (2) operate dispenser 32 to dispense (blanket dispense or selectively dispense) a new layer of powder on the upper surface 24, (3) operate the consolidation module 40 to selectively consolidate the new layer of powder, and then repeat steps 1-3 to finish fabrication of the 3D article. The controller can also operate powder dispenser 34 and other components of print engine 4 as part of the fabrication.

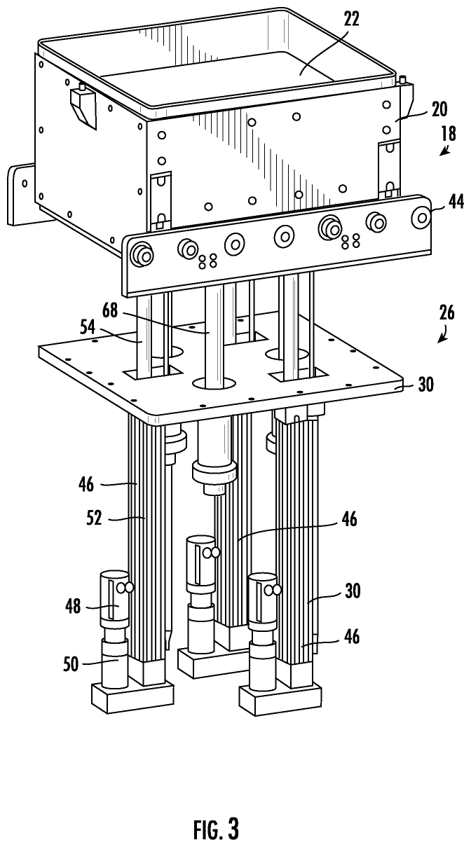

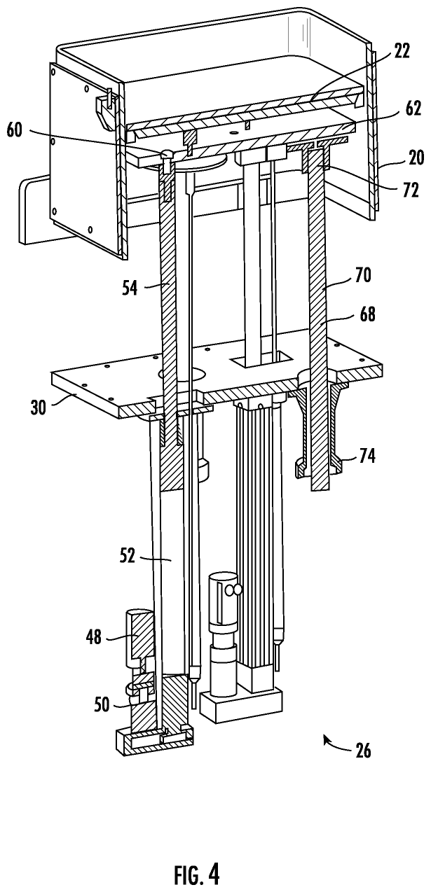

FIGS. 3 and 4 illustrate the build box 18, the vertical positioning system 26, and a portion of the chassis 30. FIGS. 3 and 4 are isometric and cutaway views respectively. In the illustrated embodiment, the build box 18 is a very strong metal box capable of holding up to about 4 tons or about 8,000 pounds of metal powder. The illustrated build plate 22 has a lateral area of about one square meter. The build box 18 includes rollers 44 to enable the build box 18 to be transported along a pair of rails which are part of the transport apparatus 12.

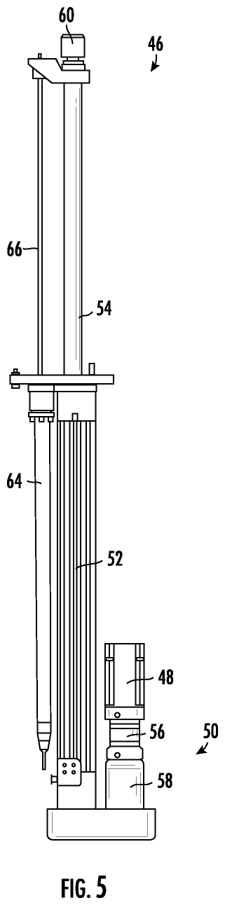

The vertical positioning system 26 includes three actuators 46. The three actuators 46 individually include a motor 48, a gear train 50, a lead screw 52, and a follower 54. FIG. 5 is a side view of one actuator 46 in isolation.

The motor 48 includes a circular encoder (not shown, internal to motor 48). The controller 16 is configured to operate the motor 48 and to receive a signal from the encoder indicative of a rate of rotation of the motor 48. The controller 16 is configured to compute a vertical velocity of the build plate 22 based upon the signal from the circular encoders.

The gear train 50 is a series of engaged gears mounted on one or more frames. The gears provide a gear reduction from a motor shaft of the motor 48 to the lead screw 52. The gear reduction results in the lead screw 52 turning at an angular velocity that is reduced from an angular velocity of the motor shaft.

The gear train 50 includes an upper gear box 56 and a lower gear box 58 (FIG. 5). The upper gear box 56 reduces a motor rotational velocity by a ratio of 4 to 1. The lower gear box 58 further reduces the rotational velocity by a ratio of 40 to 1. Thus, the overall reduction in rotational velocity from motor 48 shaft to lead screw 52 is 160 to 1.

The lead screw 52 (a vertical rod-shaped member with outer threads not specifically shown except for the location indicated by element number 52) is vertically fixed and rotates within a threaded lead nut that is a part of the follower 54. Thus, rotation of the lead screw 52 by motor 48 causes the follower 54 to translate up or down depending upon an angular direction of rotation of motor 48. At the top of the follower 54 is a coupler 60.

Referring to FIG. 4, the vertical positioning system includes a lift plate 62 configured for engaging and supporting a lower side of the build plate 22. The coupler 60 is coupled to the lift plate 62.

Referring to FIG. 5, the actuator 46 includes a linear encoder 64 with follower 66. The linear encoder 64 is configured to output a signal to controller 16 that is indicative of a vertical position of the coupler 60. The controller 16 is configured to compute a vertical position of the build plate 22 and/or lift plate 62 based upon the signal from the linear encoder 64.

Referring to FIG. 4 the vertical positioning system 26 includes three cylindrical linear bearing assemblies 68 configured to provide lateral stability for the lift plate 62. The cylindrical linear bearings 68 individually include a cylindrical guide rod 70 that is attached to the lift plate 62 at an upper end 72 of the guide rod 70. The guide rod 70 slides within a bushing 74 that is mounted to a lower side of the chassis 30. Bushing 74 constrains the guide rod 70 to a vertical orientation of its axis and vertical motion.

The controller 16 is configured to separately control each of the actuators 46 to maintain an orientation of the build plate 22 about the horizontal lateral axes X and Y such that a planar upper surface 24 of the build plate 22 or the 3D article 3 is generally parallel to the build plane 25. Signals from the three linear encoders 66 can be processed and used to determine the orientation and the controller is configured to operate the three actuators 46 independently to maintain required parallelism between upper surface 24 and build plane 25.

The specific embodiments and applications thereof described above are for illustrative purposes only and do not preclude modifications and variations encompassed by the scope of the following claims.

What is claimed:

1. A three-dimensional (3D) printing system configured to fabricate a 3D article comprising:
chassis defining a build chamber;
a build box including a build plate;
a vertical movement mechanism including a plurality of actuators configured to collectively provide precise positioning of the build plate;
a powder dispensing module;
a consolidation module; and
a controller configured to:
operate the vertical movement mechanism including operating the plurality of actuators to position an upper surface of the 3D article generally proximate and parallel to a build plane;
operate the powder dispensing module to dispense a new layer of powder over the upper surface;
operate the consolidation module to selectively consolidate the new layer of powder; and
repeat operating the vertical movement mechanism, the powder dispensing module, and the consolidation module to complete fabrication of the 3D article.

2. The 3D printing system of claim 1 wherein the build plate has a lateral area of at least 0.5 square meter and the build box is configured to support more than 2,000 pounds of material during operation of the vertical movement mechanism.

3. The 3D printing system of claim 2 wherein the build box is configured to support more than 6,000 pounds of material during operation of the vertical movement mechanism.

4. The 3D printing system of claim 2 wherein the vertical movement mechanism is configured to vertically position the build plate with a vertical tolerance of less than 20 microns.

5. The 3D printing system of claim 2 wherein the vertical movement mechanism is configured to vertically position the build plate with a vertical tolerance of less than 10 microns.

6. The 3D printing system of claim 1 wherein the plurality of actuators individually include a motor coupled to a gear train having a rotational gear reduction of at least 80 to 1.

7. The 3D printing system of claim 1 wherein the plurality of actuators individually include a linear encoder.

8. The 3D printing system of claim 1 wherein the plurality of actuators individually include a rotary encoder.

9. The 3D printing system of claim 1 further comprising:
a lift plate configured to support the build plate, the three actuators are configured to individually engage the lift plate.

10. The 3D printing system of claim 9 further comprising at least one cylindrical linear bearing assembly including a bushing coupled to the chassis and a cylindrical rod that passes through the bushing and is mounted to the lift plate.

11. A three-dimensional (3D) printing system configured to fabricate a 3D article comprising:
chassis defining a build chamber;
a build box including a build plate configured to contain the 3D article and surrounding unbound powder;
a vertical movement mechanism including:
a lift plate for engaging and supporting a lower side of the build plate;
three actuators configured to engage and vertically position the lift plate;
a powder dispensing module;
a consolidation module; and
a controller configured to:
operate the vertical movement mechanism including operating the three actuators to position an upper surface of the 3D article generally proximate and parallel to a build plane;
operate the powder dispensing module to dispense a new layer of powder over the upper surface;
operate the consolidation module to selectively consolidate the new layer of powder; and
repeat operating the vertical movement mechanism, the powder dispensing module, and the consolidation module to complete fabrication of the 3D article.

12. The 3D printing system of claim 11 wherein the build plate has a lateral area of at least 0.5 square meter and the build box is configured to support more than 2,000 pounds of material during operation of the vertical movement mechanism.

13. The 3D printing system of claim 12 wherein the build box is configured to support more than 6,000 pounds of material during operation of the vertical movement mechanism.

14. The 3D printing system of claim 12 wherein the vertical movement mechanism is configured to vertically position the build plate with a vertical tolerance of less than 20 microns.

15. The 3D printing system of claim 12 wherein the vertical movement mechanism is configured to vertically position the build plate with a vertical tolerance of less than 10 microns.

16. The 3D printing system of claim 11 wherein the three actuators individually include a motor coupled to a gear train having a rotational gear reduction of at least 80 to 1.

17. The 3D printing system of claim 11 wherein the three of actuators individually include a rotary encoder and a linear encoder.

18. The 3D printing system of claim 11 further comprising at least one cylindrical linear bearing assembly configured to maintain a horizontal stability of the lift plate.

19. A three-dimensional (3D) printing system configured to fabricate a 3D article comprising:
chassis defining a build chamber;
a build box including a build plate configured to contain the 3D article and surrounding unbound powder;
a vertical movement mechanism including:
a lift plate for engaging and supporting a lower side of the build plate;
a plurality of actuators coupled to the chassis and configured to independently engage and vertically position the lift plate;
a plurality of cylindrical linear bearing assemblies configured to maintain a horizontal stability of the lift plate;
a powder dispensing module;
a consolidation module; and
a controller configured to:
operate the vertical movement mechanism including operating the plurality of actuators to position an upper surface of the 3D article generally proximate and parallel to a build plane;
operate the powder dispensing module to dispense a new layer of powder over the upper surface;
operate the consolidation module to selectively consolidate the new layer of powder; and
repeat operating the vertical movement mechanism, the powder dispensing module, and the consolidation module to complete fabrication of the 3D article.

20. The three-dimensional (3D) printing system of claim 19 wherein the plurality of actuators individually include:
a motor;
a gear train coupled to the motor and having a rotational gear reduction of at least 80 to 1,
a lead screw coupled to the gear train; and
a follower engaging the lift plate and coupled to the lead screw to move vertically in response to rotation of the lead screw.
